(19) United States
(12) Patent Application Publication
(10) Pub. No.: US 2026/0195905 A1
(43) Pub. Date: Jul. 9, 2026

(54) MOBILE STRUCTURE TRACKING DEVICE, AUTOMATIC MOBILE STRUCTURE CONTROL SYSTEM, MOBILE STRUCTURE TRACKING METHOD, AND MOBILE STRUCTURE TRACKING PROGRAM

(71) Applicant: FURUNO ELECTRIC CO., LTD., Hyogo (JP)

(72) Inventor: Kazuya KISHIMOTO, Hyogo (JP)

(73) Assignee: FURUNO ELECTRIC CO., LTD., Hyogo (JP)

(21) Appl. No.: 19/560,829

(22) Filed: Mar. 9, 2026

Related U.S. Application Data
(63) Continuation of application No. PCT/JP2024/023568, filed on Jun. 28, 2024.

(30) Foreign Application Priority Data
Oct. 24, 2023 (JP) 2023-182748

(51) Int. Cl. G06T 7/246; B63B 79/15; G06T 7/33; G06V 10/764; G08G 3/02

(52) U.S. Cl. CPC G06T 7/248; B63B 79/15; G06T 7/33; G06V 10/764; G06T 2207/10028; G06T 2207/30252; G08G 3/02

(57) ABSTRACT

The mobile structure tracking device includes processing circuitry. The processing circuitry acquires point cloud data comprising a plurality of feature points obtained by ranging a surrounding environment including another ship with respect to an own ship, sets individual areas for the plurality of feature points based on a distribution of positions of the plurality of feature points, selects the target tracking ship based on the size of the individual areas, and generates tracking data based on a time-series change of the positions of the target tracking ship.

### CROSS-REFERENCE TO RELATED APPLICATION(S)

This application is a continuation application of PCT International Application No. PCT/JP2024/023568, which was filed on Jun. 28, 2024, and which claims priority to Japanese Patent Application No. JP2023-182748 filed on Oct. 24, 2023, the entire disclosures of each of which are herein incorporated by reference for all purposes.

### TECHNICAL FIELD

The present invention relates to a technology for tracking another mobile structure.

### BACKGROUND

Conventionally, there is a technology for tracking a target, such as another ship, using radar.

### SUMMARY

However, a radar cannot detect a target object in a small area near a ship such as a port or a narrow channel, and cannot track the target object.

Therefore, the present invention provides a technology that may track the target object even in a small area near the ship.

A mobile structure tracking device is provided with processing circuitry. The processing circuitry acquires point cloud data comprising a plurality of feature points obtained by a sensor ranging a surrounding environment including another ship with respect to an own ship, sets an individual area for the plurality of feature points based on a distribution of positions of the plurality of feature points, selects a target tracking ship based on a size of the individual area, and generates tracking data based on time-series changes in a position of the target tracking ship.

In this configuration, the mobile structure tracking device may detect objects such as land and ships at a short distance that is impossible by radar. Furthermore, the mobile structure tracking device may select a ship (i.e., target of tracking) from the objects. The mobile structure tracking device may further detect the change of the position of the ship, and may generate tracking data of the ship. Thus, the mobile structure tracking device may track the ship (target) even to a narrow area in a vicinity of the ship, and in the mobile structure tracking device of the present invention, the feature points are represented by three-dimensional position coordinates.

Additionally, or optionally, the plurality of feature points are three-dimensional position coordinates.

Additionally, or optionally, the processing circuitry is further configured to set the individual area using the three-dimensional position coordinates. Further, the processing circuitry is further configured to generate the tracking data based on two-dimensional position coordinates generated by converting the three-dimensional position coordinates into the two dimensional position coordinates.

Additionally, or optionally, the processing circuitry is further configured to accumulate the point cloud data at a plurality of times. Further, the processing circuitry is further configured to perform alignment of the plurality of feature points included in the point cloud data at the plurality of times using SLAM processing. Furthermore, the processing circuitry is further configured to set the individual area based on the performing of the alignment of the plurality of feature points.

Additionally, or optionally, the processing circuitry is further configured to classify a type of the individual area. Further, the processing circuitry is further configured to select the target tracked ship based on the type of the individual area.

Additionally, or optionally, the processing circuitry is further configured to select whether or not to use SLAM processing in accordance with a ratio of the individual area classified as a land in a detection area by the sensor.

Additionally, or optionally, the processing circuitry is further configured to perform the alignment without using the SLAM processing when the ratio is equal to or less than a threshold ratio.

Additionally, or optionally, the processing circuitry is further configured to measure a position and an attitude of the own ship. Further, the processing circuitry is further configured to perform the alignment using the position and the attitude of the own ship when the SLAM processing is not used.

Additionally, or optionally, the processing circuitry is further configured to set the individual area for each set of feature points from the plurality of feature points having a distance between adjacent feature points at the same time is equal to or less than an area setting threshold.

Additionally, or optionally, the processing circuitry is further configured to classify the type of the individual area as the land when a size of the individual area is greater than or equal to a classification threshold, and classify the type of the individual area as a ship when the size of the individual area is less than the classification threshold.

Additionally, or optionally, the processing circuitry is further configured to classify the type of the individual area as the land when the individual area classified as the land existing between the individual area to be classified and the own ship.

Additionally, or optionally, the processing circuitry is further configured to classify the plurality of feature points as noise when a number of the feature points constituting the individual area is less than a noise classification threshold.

Additionally, or optionally, the processing circuitry is further configured to convert a three-dimensional position of the plurality of feature points of the individual area that is not classified as the noise into a two-dimensional position, and determine the type of the individual area as the ship or the land based on the converted individual area.

Additionally, or optionally, the processing circuitry is further configured to determine whether or not the individual area at the plurality of time is caused by a same target object based on position coordinates at the plurality of time. Further, the tracking unit is configured to calculate a time-series change of the position coordinates of the same target object.

Additionally, or optionally, the processing circuitry is further configured to calculate a vertical length or a horizontal length of the individual area at the plurality of times determined to be the same target object. The processing circuitry is further configured to calculate a change amount of the vertical length or the horizontal length at the plurality of times. The processing circuitry is further configured not calculate the time-series change of the position coordinates of the same target object when the change amount of the vertical length or horizontal length at the plurality of times is equal to or greater than a change threshold.

Additionally, or optionally, the processing circuitry is further configured to not generate the tracking data for the target tracked ship corresponding to the individual area comprising the plurality of feature points included in a farthest area in the detection area by the sensor, or the plurality of feature points having a number of times acquired is less than or equal to a threshold for the number of times acquired.

Additionally, or optionally, the processing circuitry is further configured to generate display data based on the tracking data.

Additionally, or optionally, the mobile structure tracking device further comprises a display device configured to display the display data.

Additionally, or optionally, the processing circuitry is further configured to generate the display data having a different display mode according to a state of the target tracked ship.

An automatic mobile structure control system is provided. The automatic mobile structure control system comprises the mobile structure tracking device, and a navigation control device configured to perform an automatic navigation control to follow the target tracked ship or avoid collision with the target tracked ship based on the tracking data.

A ship tracking method is provided. The ship tracking method comprises acquiring point cloud data comprising a plurality of feature points obtained by a sensor ranging a surrounding environment including another ship with respect to an own ship. The ship tracking method further comprises setting an individual area for the plurality of feature points based on a distribution of positions of the plurality of feature points. Further, the ship tracking method comprises selecting a target tracked ship based on a size of the individual area. Furthermore, the ship tracking method comprises generating tracking data based on time-series changes in a position of the target tracked ship.

A ship tracking program is provided. The ship tracking program, used in a mobile structure tracking device, causing a computer to execute processing configured to acquire point cloud data comprising a plurality of feature points obtained by a sensor ranging a surrounding environment including another ship with respect to an own ship. The ship tracking program,, used in a mobile structure tracking device, causing a computer to further execute processing configured to set an individual area for the plurality of feature points based on a distribution of positions of the plurality of feature points. Further, the ship tracking program, used in a mobile structure tracking device, causing a computer to execute processing configured to select a target tracked ship based on a size of the individual area, and generate tracking data based on time-series changes in a position of the target tracked ship.

In the configuration, for example, shows an aspect using LiDAR, and each object table including the ship (target) may be detected at a three-dimensional position, and the detection performance is improved.

In the configuration, the tracking processing load may be reduced without reducing the tracking accuracy for the target tracking ship.

In the configuration, the mobile structure tracking device may align the feature points of the plurality of times with high accuracy. Thus, the mobile structure tracking device may set the individual areas with high accuracy.

In the configuration, the target tracking ship may be selected from a plurality of individual areas before tracking. As a result, the mobile structure tracking device may track only the target tracking ship that needs tracking.

In the configuration, the mobile structure tracking device may determine whether or not SLAM processing is effective. Thus, when SLAM processing is not effective, another processing may be set.

In the configuration, the mobile structure tracking device may be aligned with predetermined accuracy even when the SLAM processing is not effective.

In the configuration, the mobile structure tracking device may be aligned with high accuracy even when SLAM processing is not effective.

In the configuration, individual areas are set by a plurality of feature points adjacent to each other. Thus, the mobile structure tracking device may properly set the individual areas.

In the configuration, the mobile structure tracking device may properly classify land and ship.

In the configuration, the mobile structure tracking device may properly classify land.

In the configuration, land, ships to be tracked, and noise may be properly classified.

In the configuration, the noise may be properly classified for land and ships to be tracked, and land and ships to be tracked may be properly classified while suppressing deterioration of classification accuracy.

In the configuration, the mobile structure tracking device may accurately judge individual areas of multiple times corresponding to one object mark, and may suppress erroneous tracking.

In the configuration, the mobile structure tracking device stops tracking when the shape (longitudinal and/or lateral length) of the tracked object changes significantly. This allows the mobile structure tracking device to suppress suspicious tracking.

In the configuration, the mobile structure tracking device does not use feature points with low reliability, so that tracking accuracy may be improved.

In the configuration, the mobile structure tracking device may provide the tracking result (including, for example, the direction of travel and the track) of the ship (target) in a displayable form.

In the configuration, the mobile structure tracking device may display the tracking result (including, for example, the direction of travel and the track) of the ship (target). Thus, the user may easily view the tracking result of the ship (target).

In the configuration, the mobile structure tracking device may display the tracking result of the ship (target) so that the user can easily see it.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a functional block diagram of a mobile structure tracking device according to a first embodiment of the present invention;

FIG. 2 is a functional block diagram of an area setting unit according to a first embodiment of the present invention;

FIG. 3A is a plan view showing an example of the sea situation of the narrow channel including the ship, and FIG. 3B is a plan view showing an example of the distribution of feature points in the situation of FIG. 3A;

FIG. 4 is a diagram showing an example of area division;

FIG. 5 is a functional block diagram of a classification unit according to a first embodiment of the present invention;

FIG. 6 is a diagram showing an example of classification;

FIG. 7 is a functional block diagram of a tracking unit according to a first embodiment of the present invention;

FIG. 8A shows an example of judging to the same ship, and FIG. 8B shows an example of judging to another ship;

FIG. 9A is a diagram showing an example of continuation of tracking, and FIG. 9B is a diagram showing an example of discontinuation of tracking;

FIG. 10A is a diagram showing an example of a sea situation serving as a judgment standard with SLAM processing, and FIG. 10B is a diagram showing an example of a sea situation serving as a judgment standard without SLAM processing;

FIG. 11 is a flowchart showing an example of a ship tracking method according to a first embodiment of the present invention;

FIG. 12 is a flowchart showing an example of an area dividing method;

FIG. 13 is a flowchart showing an example of an alignment method;

FIG. 14 is a flowchart showing an example of a classification method;

FIG. 15 is a flowchart showing an example of a tracking method;

FIG. 16 is a flowchart showing an example of a method for determining a tracking object;

FIG. 17 is a flowchart showing an example of a method for selecting continuation of tracking and termination of tracking;

FIG. 18 is a functional block diagram of a mobile structure tracking device according to a second embodiment of the present invention;

FIG. 19 is a diagram showing an example of a display;

FIG. 20 is a functional block diagram of a tracking unit in a mobile structure tracking device according to a third embodiment of the present invention; and

FIG. 21 is a functional block diagram of a ship automatic steering system according to a fourth embodiment of the present invention.

### DETAILED DESCRIPTION

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

Embodiments of the present invention will now be described with reference to the drawings. The same reference numerals are used for the same or equivalent portions in the drawings, and the description is not repeated. In addition, at least a part of the following embodiments may be optionally combined.

A ship tracking technique according to a first embodiment of the present invention will be described with reference to the figure.

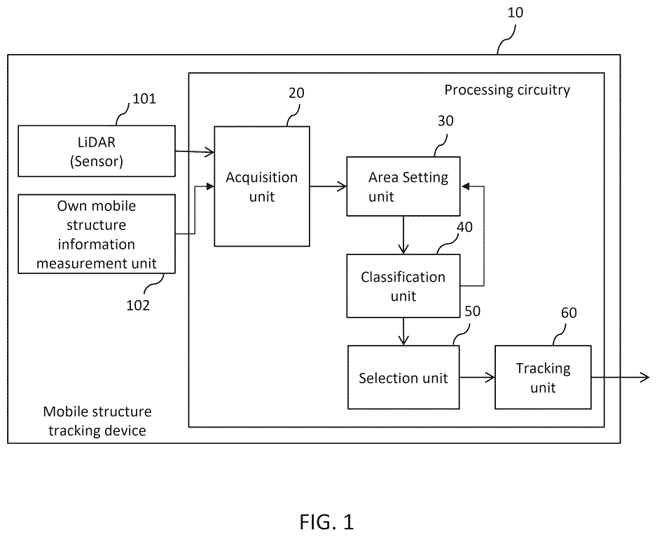

(Schematic configuration and schematic processing of a mobile structure tracking device 10) FIG. 1 is a functional block diagram of a mobile structure tracking device according to a first embodiment of the present invention. As shown in FIG. 1, the mobile structure tracking device 10 includes a Light Detection And Ranging (LiDAR) 101 (as a sensor for ranging), an own mobile structure information measurement unit 102, an acquiring unit 20, an area setting unit 30, a classification unit 40, a selection unit 50, and a tracking unit 60. In one embodiment, the acquiring unit 20, the area setting unit 30, the classification unit 40, the selection unit 50, and the tracking unit 60 may be collectively referred to as a processing circuitry.

Although the LiDAR 101 and the own mobile structure information measurement unit 102 are functionally included in the mobile structure tracking device 10, the LiDAR 101 and the own mobile structure information measurement unit 102 are separate from the functional units after the acquiring unit 20. The functional units after the acquiring unit 20 are composed of, for example, arithmetic processing devices such as various computer devices. If the mobile structure tracking device 10 is configured to acquire point cloud data and own ship information from outside, the configuration may not include the LiDAR 101 and the own ship information measuring unit 102.

The LiDAR 101 is a device that performs the Light Detection And Ranging. The LiDAR 101 irradiates a detection area around the ship by scanning a laser beam for detection in two dimensions. The LiDAR 101 receives a reflected light reflected by a target object by the laser beam for detection. The LiDAR 101 measures a distance and a direction of the target object from its own device using an irradiation time of the laser beam, a reception time of the reflected light, and a scanning angle.

Further, the LiDAR 101 detects a point at which a reception intensity of the reflected light is greater than or equal to a threshold, and makes it a feature point. The LiDAR 101 outputs the reception intensity (i.e., a reflection intensity) of the reflected light at the feature point (i.e., reflection point) and three-dimensional position coordinates of the feature point as feature point data. The LiDAR 101 generates and outputs the feature point data for a plurality of feature points in the detection area.

In one embodiment, a set of a plurality of feature point data is point cloud data, and the LiDAR 101 outputs the set of the plurality of feature point data obtained by scanning the laser beam once as point cloud data with one timing.

Further, the own ship information measuring unit 102 includes a positioning sensor and an attitude sensor. The own ship information measuring unit 102 detects a position and an attitude of the own ship and outputs the three-dimensional position coordinates and the attitude of the own ship as own ship information.

The acquiring unit 20 acquires the point cloud data from the LiDAR 101 and own ship information (i.e., the three-dimensional position coordinates and the attitude) from the own ship information measuring unit 102. The acquiring unit 20 acquires the point cloud data and own ship information at multiple times. The acquiring unit 20 outputs the point cloud data and the own ship information at multiple times to the area setting unit 30.

The area setting unit 30 divides the plurality of feature point data included in the point cloud data into a plurality of individual areas based on a distribution of position coordinates of the plurality of feature points included in the point cloud data. The individual areas are partial areas generated by dividing the entire detection area. In other words, the area setting unit 30 sets each of the plurality of feature point data to be included in one of the plurality of individual areas.

The area setting unit 30 outputs the divided plurality of individual areas to the classification unit 40. The information contained in the individual areas includes a plurality of feature point data assigned to each individual area.

The classification unit 40 calculates a size of each individual area and classifies a type of the individual area based on the size. The size of the individual area is the area where the individual area is projected on a horizontal plane. The classification unit 40 sets a classification threshold, compares the size of the individual area with the classification threshold, and classifies the type of the individual area based on the comparison result. In one embodiment, the types of classification comprises a land, a ship, and a noise.

The classification unit 40 outputs the individual areas and the classification to the selection unit 50. The classification of the individual areas is fed back to the area setting unit 30.

Further, the selection unit 50 selects the individual areas classified as ships.

The tracking unit 60 further generates tracking data based on a time-series change of the position coordinates of the tracked ships by using the individual areas classified as the ships, for example, the tracked ships. In one embodiment, the tracking unit 60 converts the position coordinates of a three-dimensional coordinate system into a two-dimensional coordinate system parallel to the horizontal plane to generate the tracking data.

Further, the mobile structure tracking device 10 may detect a ship (i.e., a tracking object) at a plurality of times using a short-range light ranging technique. The mobile structure tracking device 10 may track the ship (i.e., a tracking object or a target) even to a narrow area in the vicinity of its own ship. The tracking object may not be limited to a ship but may be an obstacle on the water.

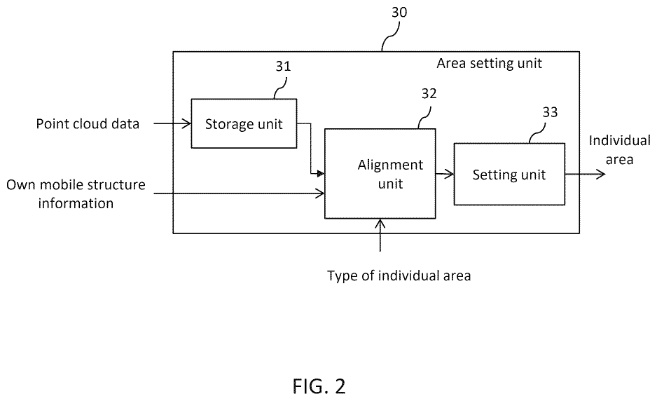

(Concrete configuration and processing of each unit of the mobile structure tracking device 10) FIG. 2 is a functional block diagram of the area setting unit according to the first embodiment of the present invention.

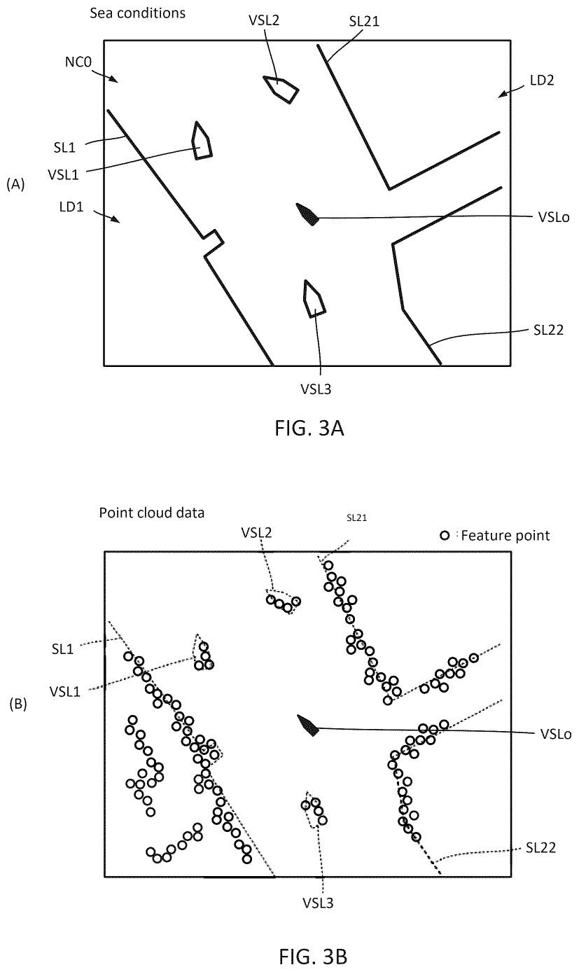

FIG. 3A is a plan view showing an example of a sea situation of a narrow channel including the ship, and FIG. 3B is a plan view showing an example of the distribution of feature points in the situation of FIG. 3A. In the subsequent drawings including FIG. 3B, the feature points are indicated by ○, but they are enlarged and thinned out appropriately so as to make it easy to see and understand.

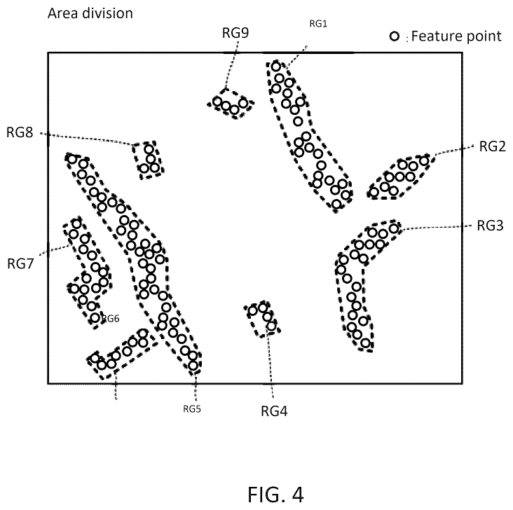

FIG. 4 is a diagram showing an example of the area division. FIG. 4 is a diagram of the sea situation shown in FIG. 3A.

As shown in FIG. 2, the area setting unit 30 includes a storage unit 31, an alignment unit 32, and a setting unit 33.

The storage unit 31 receives multi-time point cloud data and multi-time own ship information (i.e., the position coordinates and the attitude of the own ship).

In one example, in the case shown in FIG. 3A, the own ship VSLo is traveling in a narrow channel NC0. Further, Land LD1 and LD2 exist around the vicinity of the own ship VSLo, and ships (i.e., other ships) VSL1, VSL2, and VSL3 different from the own ship VSLo exist in the narrow channel NC0 sandwiched between land LD1 and LD2.

In the case of FIG. 3A, as shown in FIG. 3B, edges of the land LD1 and LD2, the construction of land LD1, and the reflected light of ships VSL1, VSL2, and VSL3 are almost punctate. In one aspect, characteristic point is that the reflected light is generated in a substantially punctate shape, and is distributed according to the shape and the attitude of the ships VSL1, VSL2 and VSL3, such as the shape of the land LD1 and LD2.

In one embodiment, the point cloud data composed of the characteristic points (i.e., feature point data: received intensity of the reflected light, the three-dimensional position coordinates) distributed is input to the storage unit 31.

The storage unit 31 stores the point cloud data and the own ship information. Further, the storage unit 31 stores the point cloud data and the own ship information associated with each other at the same time.

The storage unit 31 outputs the accumulated point cloud data and the own ship information at multiple times to the alignment unit 32.

The alignment unit 32 corrects the position coordinates (i.e., three-dimensional position coordinates) of the feature point data at multiple times constituting the point cloud data at multiple times by using the own ship information (i.e., the position coordinates and the attitude of the own ship) when the respective feature point data are acquired.

Further, the alignment unit 32 performs alignment of the feature point data at a plurality of times using a SLAM (Simultaneous Localization and Mapping) processing.

The alignment unit 32 performs the alignment of the feature point data at a plurality of times using the own ship information and chart information without using the SLAM processing. The own ship information includes the position coordinates and the attitude of the own ship. The position coordinates and the attitude of the own ship are measured by the own ship information measuring unit (not shown) using, for example, GPS.

A specific method of selecting the SLAM processing is described later.

The alignment unit 32 outputs the feature point data of the plurality of times of the alignment to the setting unit 33.

The setting unit 33 performs division setting into the plurality of individual areas based on the feature point data of the aligned plurality of times.

In one embodiment, the setting unit 33 calculates a distance between adjacent feature points with respect to the plurality of feature point data of the same time. The setting unit 33 stores a threshold value for setting the area.

The setting unit 33 determines the individual area for each set of the plurality of feature point data having the distance between the adjacent feature points is equal to or less than the threshold value for setting the area.

In one example, in the case of FIG. 4, the setting unit 33 identifies a set having the distance between the adjacent feature points is equal to or less than the threshold value for setting the area, and sets the plurality of individual areas RG1-RG9.

The setting unit 33 outputs the identified individual areas to the classification unit 40.

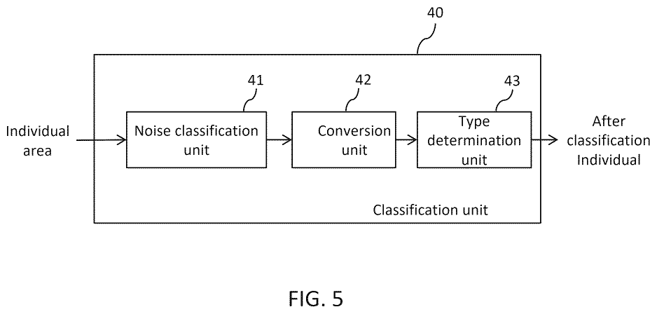

FIG. 5 is a functional block diagram of the classification unit 40 according to a first embodiment of the present invention.

As shown in FIG. 5, the classification unit 40 includes a noise classification unit 41, a conversion unit 42, and a type discrimination unit 43.

The noise classification unit 41 measures a number of feature points constituting each individual area for each of the plurality of individual areas. The noise classification unit 41 sets a threshold for noise classification for the number of feature points.

The noise classification unit 41 classifies the individual areas as noise when the number of feature points constituting the individual areas is less than the threshold for the noise classification.

If the number of feature points constituting the individual area is equal to or greater than the threshold for the noise classification, the noise classification unit 40 classifies the individual area as not being noise.

Further, the noise classification unit 40 outputs the individual area classified as not being noise to the conversion unit 42.

The conversion unit 42 converts the three-dimensional position coordinates of the plurality of feature point data constituting the input as the individual area into two-dimensional position coordinates. In one embodiment, the conversion unit 42 projects the plurality of feature point data represented by the three-dimensional coordinate system constituting the individual area onto the horizontal plane, and converts the three-dimensional coordinate system into the two-dimensional coordinate system parallel to the horizontal plane. The conversion unit 42 outputs the individual area converted into the two-dimensional position coordinates to the type discrimination unit 43.

The type discrimination unit 43 further calculates the area (size) of a plurality of individual areas not classified as noise. Since the individual areas have been converted to two-dimensional position coordinates, the area of the plurality of individual areas is the area of the plurality of individual areas projected on a horizontal plane.

The type discrimination unit 43 stores a threshold value for classification. The threshold value for classification is set, for example, to classify individual areas into the land and the ship in descending order.

The type discrimination unit 43 compares the area of a plurality of individual areas not classified as noise with the threshold value for classification. If the area is less than the threshold value for classification, the type discrimination unit 43 classifies the type of the individual areas as the ship. If the area is greater than or equal to the threshold value for classification, the type discrimination unit 43 classifies the type of the individual areas as the land.

Further, if the individual areas classified as the land exist between the individual areas to be classified as the ship, the type discrimination unit 43 classifies the type of the individual areas to as the land.

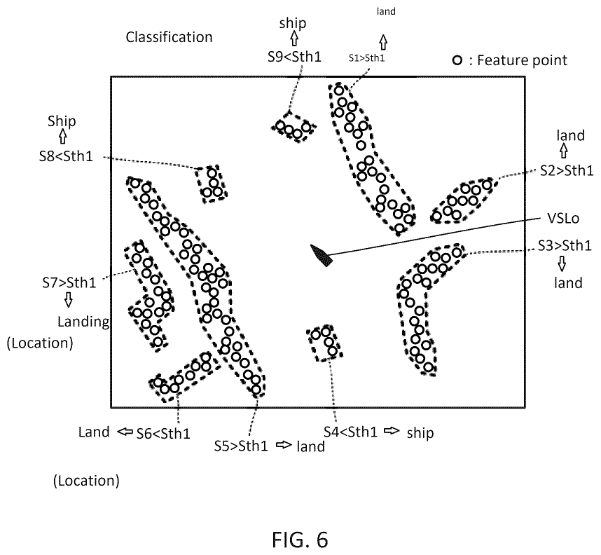

FIG. 6 is a diagram showing an example of classification. In one embodiment, FIG. 6 is a diagram in the sea situation shown in FIG. 3A.

In one example, in the case of FIG. 6, the type discrimination unit 43 calculates the areas S1-S9 from the plurality of individual areas RG1-RG9 that are not classified as the noise. The type discrimination unit 43 classifies the plurality of individual areas RG1-RG9 into one of the land or the ship based on the areas S1-S9.

In one embodiment, the type discrimination unit 43 compares the areas S1-S9 with the classification threshold Sth1. The type discrimination unit 43 determines that the areas S1, S2, S3, S5, S6, and S7 are greater than the classification threshold Sth1, and classifies the plurality of individual areas RG1, RG2, RG3, RG5, RG6, and RG7 into the land. Further, the type discrimination unit 43 determines that the areas S4, S8, and S9 are less than the classification threshold Sth1, and classifies the plurality of individual areas RG4, RG8, and RG9 into the ship.

Further, an individual area RG5 is classified as the land exists between the plurality of individual areas RG6 and RG7 and the ship VSLo. The type discrimination unit 43 determines that the individual area RG5 exists between the plurality of individual areas RG6 and RG7 and the ship VSLo from the position coordinates (i.e., the position coordinates of a center point of each individual area) of the individual areas RG5, RG6 and RG7 and the ship VSLo.

In one embodiment, the type discrimination unit 43 classifies the plurality of individual areas RG6 and RG7 as the land even if the areas S6 and S7 of the individual areas RG6 and RG7 are less than the classification threshold Sth1.

Based on performing such processing, the classification unit 40 may accurately classify the plurality of individual areas.

The classification unit 40 outputs the individual areas classified as the land or the ship to the selection unit 50. The individual areas output from the classification unit 40 include the area and the classified type.

(Selection unit 50) The selection unit 50 selects the individual area classified as the ship and outputs the selected individual area to the tracking unit 60.

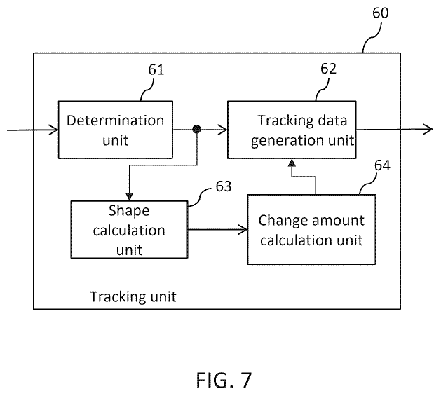

(Tracking unit 60) FIG. 7 is a functional block diagram of the tracking unit according to the first embodiment of the present invention.

The tracking unit 60 includes a determination unit 61, a tracking data generation unit 62, a shape calculation unit 63, and a change amount calculation unit 64.

The determination unit 61 determines whether the individual areas of the plurality of times are caused by the same object mark based on the position coordinates of the plurality of times.

In one embodiment, the determination unit 61 calculates the position coordinates of the individual areas of the plurality of times used for determination. The position coordinates of the individual areas are, for example, the position coordinates of the center of a smallest external shape containing the plurality of feature point data constituting the individual areas. The external shape is, for example, a rectangle. The position coordinates of the center may be geometrically calculated from the position coordinates of the plurality of feature point data.

The determination unit 61 further calculates an amount of change (i.e., a difference of the position coordinates in the two-dimensional coordinate system) of the position coordinates of the individual areas of the plurality of times.

The determination unit 61 stores a threshold value for determination of the same object mark. The threshold value for determination of the same object mark is determined based on an upper limit of a normal navigation speed of the ship in the narrow channel.

In one embodiment, if the amount of change of the position coordinates is equal to or less than the threshold value for determination of the same object mark, the determination unit 61 determines that the individual area of the plurality of times having the amount of change of the position coordinates is calculated for the same object mark (i.e., the ship). In another embodiment, if the amount of change in the position coordinates is greater than the threshold value for determination of the same object mark, the determination unit 61 determines that the individual areas of the plurality of times having the amount of change in the position coordinates is calculated for different object marks (ships).

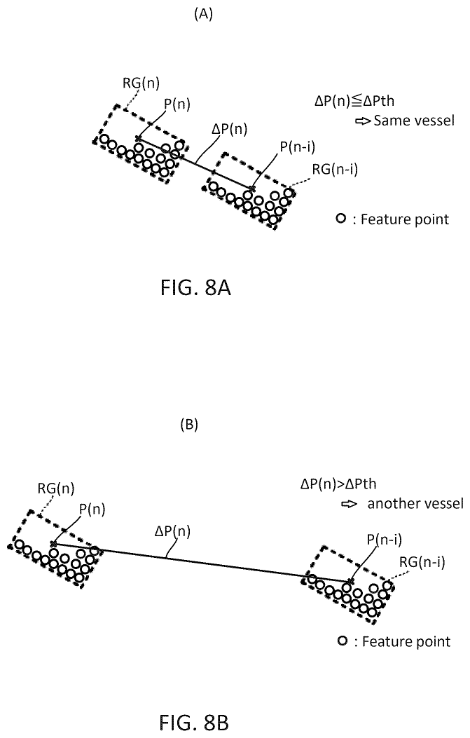

FIG. 8A is a diagram showing an example of determining the same ship, and FIG. 8B is a diagram showing an example of determining the same ship.

In one example, in the case of FIGS. 8A and 8B, the individual area RG at the first time (n-i) and the individual area RG at the second time (n) are targeted. The determination unit 61 calculates a change amount ΔP(n) between the position coordinate P(n-i) of the individual area RG at the first time (n-i) and the position coordinate P(n) of the individual area RG at the second time (n).

In the case of FIG. 8A, the change amount ΔP(n) is less than the threshold value ΔPth for determination of the same target. Further, the determination unit 61 determines that the individual area RG at the first time (n-i) and the individual area RG at the second time (n) are the same target (i.e., the ship).

In the case of FIG. 8B, the change amount ΔP(n) is greater than the threshold value ΔPth for determining the same target. Therefore, the determination unit 61 determines that the individual area RG at the first time (n-i) and the individual area RG at the second time (n) are different target (ship).

The determination unit 61 outputs the individual area at the plurality of times determined to be the same target to the tracking data generation unit 62 and the shape calculation unit 63. In one example, the determination unit 61 outputs the identification information recognizable as the same target to the individual area at the plurality of times determined to be the same target.

The tracking data generation unit 62 calculates a speed vector of the tracked target ship using the individual area at the plurality of times determined to be the same target as the tracked target ship. The tracking data generation unit 62 generates the tracking data including the identification information, the position coordinates, and the speed vector of the tracked target ship.

With this configuration, the tracking unit 60 may appropriately select and track the tracked target ship.

Further, the tracking unit 60 uses the individual areas represented by the two-dimensional position coordinates. In one embodiment, the target tracking ship moves on the horizontal plane, thus even if the tracking of the target tracking ship is performed in the two dimensions, accuracy equivalent to that in the three dimensions may be ensured. Further, the processing load in the two dimensions is lower than that in the three dimensions by one dimension. Thus, the tracking unit 60 may reduce the processing load without reducing the tracking accuracy of the tracked ship. Therefore, the tracking unit 60 may generate the tracking data with simpler processing and faster processing than using the position coordinates of the three-dimensional coordinate system.

Furthermore, the display of the tracked ship described later is performed in the two dimensions, a loss of accuracy in the display of the tracked ship may be suppressed even if the tracking is performed in the two dimensions. Therefore, the mobile structure tracking device may suppress the loss of accuracy in the display of the tracked ship while reducing the processing load.

The shape calculation unit 63 calculates each a vertical length and/or a horizontal length of the individual areas of the plurality of times determined to be the same object mark.

In one embodiment, the shape calculation unit 63 calculates the vertical length and/or the horizontal length of a smallest outline shape including the plurality of feature point data constituting the individual areas. In one example, the outline shape is a rectangle set to have sides parallel to two orthogonal axes constituting the two-dimensional coordinate system. The vertical length and/or the horizontal length may be calculated geometrically from the position coordinates of the plurality of feature point data. Further, the vertical length and/or the horizontal length of the individual area may be calculated easily by setting the individual area by a rectangle having sides parallel to two orthogonal axes.

The shape calculation unit 63 outputs the calculated vertical length and/or the horizontal length of the individual area of the plurality of times to the change amount calculation unit 64.

The change amount calculation unit 64 calculates the change amount of the vertical length and/or the horizontal length of the individual area of the plurality of times determined to be the same object mark. In one example, the change amount calculation unit 64 calculates an absolute value of the change amount of the vertical length and/or the horizontal length.

The change amount calculation unit 64 outputs the change amount of the vertical length and/or the horizontal length to the tracking data generation unit 62.

The tracking data generation unit 62 stores the threshold value for the change amount.

If the change amount of the vertical length and the horizontal length is less than the threshold value for the change amount, the tracking data generation unit 62 calculates a velocity vector of the individual area (i.e., the target tracking ship) of the identification information and generates the tracking data. Further, the tracking unit 60 continues tracking the individual area (i.e., the target tracked ship).

If the amount of change in the vertical length and/or the horizontal length is equal to or greater than the threshold for the amount of change, the tracking data generation unit 62 may not calculate the velocity vector of the individual area of the identification information and stops generating the tracking data. Further, the tracking unit 60 stops tracking the individual area (i.e., the target tracking ship).

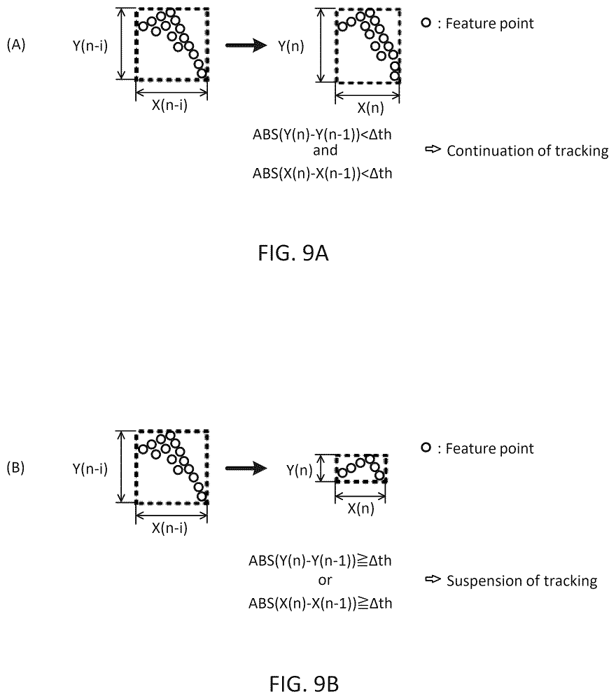

FIG. 9A is a diagram showing an example of tracking continuation, and FIG. 9B is a diagram showing an example of tracking cancellation.

In one example, in the case of FIG. 9A and FIG. 9B, the individual areas RG at the first time (n-i) and the individual areas RG at the second time (n) determined by the determination unit 61 to be the same target object are targeted.

The shape calculation unit 63 calculates the vertical length Y(n-i) and the horizontal length X(n-i) of the individual areas RG at the first time (n-i) and the vertical length Y(n) and the horizontal length X(n) of the individual areas RG at the second time (n).

The change amount calculation unit 64 calculates the change amount ABS(Yn) between the vertical length Y(n-i) and the vertical length Y(n). The change amount calculation unit 64 calculates the change amount ABS(Xn) between the horizontal length X(n-i) and the horizontal length X(n).

In the case of FIG. 9A, the change amount ABS(ΔYn) and the change amount ABS(Xn) are less than the change amount threshold value Δth. The tracking data generation unit 62 further generates the tracking data and continues the tracking.

In the case of FIG. 9B, the change amount ABS(ΔYn) is greater than the change amount threshold Δth. The tracking data generation unit 62 further stops the generation of the tracking data and stops the tracking. Further, the tracking data generation unit 62 stops the generation of the tracking data and stops the tracking, when the change amount ABS(ΔXn) is greater than the change amount threshold Δth.

With this configuration, the tracking unit 60 may suppress erroneous tracking.

In one embodiment, the tracking unit 60 may use the amount of change in the area of the individual area, instead of the amount of change in the vertical length and/or the horizontal length of the individual area, to judge whether the tracking is continued or stopped.

(Specific processing of selection of whether or not to perform the SLAM processing) The alignment unit 32 may perform selection of whether or not to perform the SLAM processing in accordance with the proportion of the individual area classified as the land by the classification unit 40.

The classification unit 40 outputs the classification result to the selection unit 50 and feeds it back to the area setting unit 30.

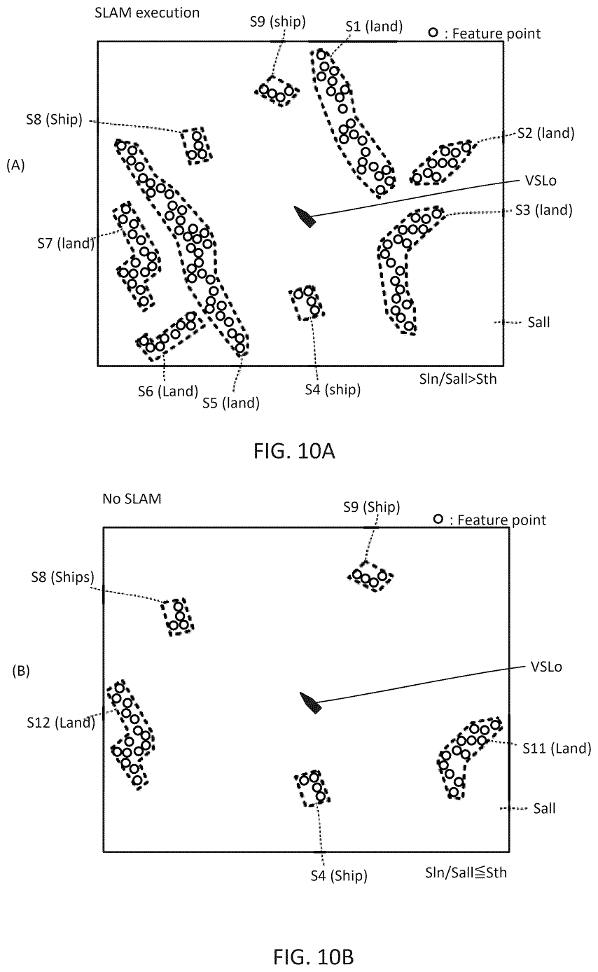

FIG. 10A is a diagram showing an example of a sea situation serving as a judgment standard with the SLAM processing, and FIG. 10B is a diagram showing an example of a sea situation serving as a judgment standard without the SLAM processing. FIGS. 10A and 10B are expressed using the plurality of feature points.

In the sea situation shown in FIG. 10A, the land and the ships are intermingled in the whole detection area by LiDAR 101, and the land is abundant. Therefore, the proportion of land in the whole detection area is large.

In the sea situation shown in FIG. 10B, there are many ships and little land in the whole detection area by LiDAR 101. Therefore, the proportion of the land in the whole detection area is small.

The alignment unit 32 acquires the area used in the classification unit 40 when classifying the land and the ships. In one embodiment, the alignment unit 32 may calculate the land area and the ship area based on whether or not the SLAM processing is executed. The alignment unit 32 stores the total area Sall of the detection area.

The alignment unit 32 calculates the total land area Sln. The alignment unit 32 further calculates a ratio of the total land area Sln to the total area Sall.

Further, the alignment unit 32 stores a ratio threshold Sth. The alignment unit 32 further compares a ratio (Sln/Sall) with a ratio threshold Sth.

In one embodiment, if the ratio (Sln/Sall) is greater than the ratio threshold Sth, the alignment unit 32 performs the SLAM processing (with SLAM processing). In one example, in the case of FIG. 10A, the total land area Sln is S1+S2+S3+S5+S6+S7, and the ratio (Sln/Sall) is large. Therefore, the ratio (Sln/Sall) may be greater than the ratio threshold Sth, and the SLAM processing is performed.

In another embodiment, if the ratio (Sln/Sall) is equal to or less than the ratio threshold Sth, the alignment unit 32 may not perform the SLAM processing (i.e., no SLAM processing). In another example, in FIG. 10B, the total land area Sln is S11+S12, and the ratio (Sln/Sall) is small. Therefore, the ratio (Sln/Sall) is equal to or less than the ratio threshold Sth, and the SLAM processing is not performed.

In one embodiment, the SLAM processing may be expected to improve the alignment accuracy if there are many position-invariant objects such as the land having absolute position coordinates (i.e., position coordinates of the earth reference) do not change. However, if there are few position-invariant objects, the alignment accuracy decreases.

Further, by not performing the SLAM processing when the proportion of land is small, and performing the SLAM processing when the proportion of land is large, the alignment unit 32 may improve the alignment accuracy by performing the SLAM processing when the proportion of land is large, and may suppress the decrease in the accuracy by performing the SLAM processing when the proportion of land is small.

The total area Sall of the detection area may be the total area detected by the LiDAR 101, or it may be the total area of a plurality of detected individual areas. That is, the total area Sall may be the total area of land and the total area of ships.

The alignment unit 32 may judge whether or not the SLAM processing is used based on the number of the classified lands. In one example, the alignment unit 32 may perform the SLAM processing if the number of lands is equal to or greater than the threshold for determining SLAM application, and may not perform SLAM processing if the number of lands is less than the threshold for determining SLAM application.

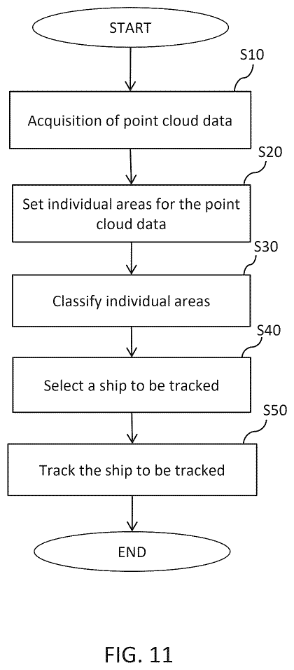

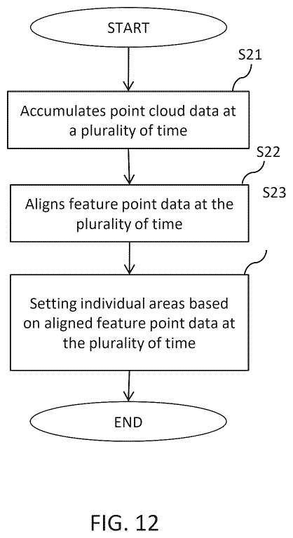

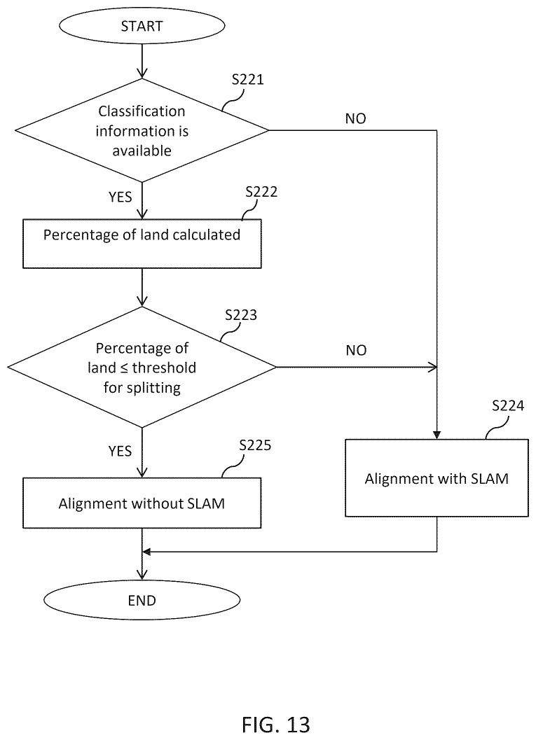

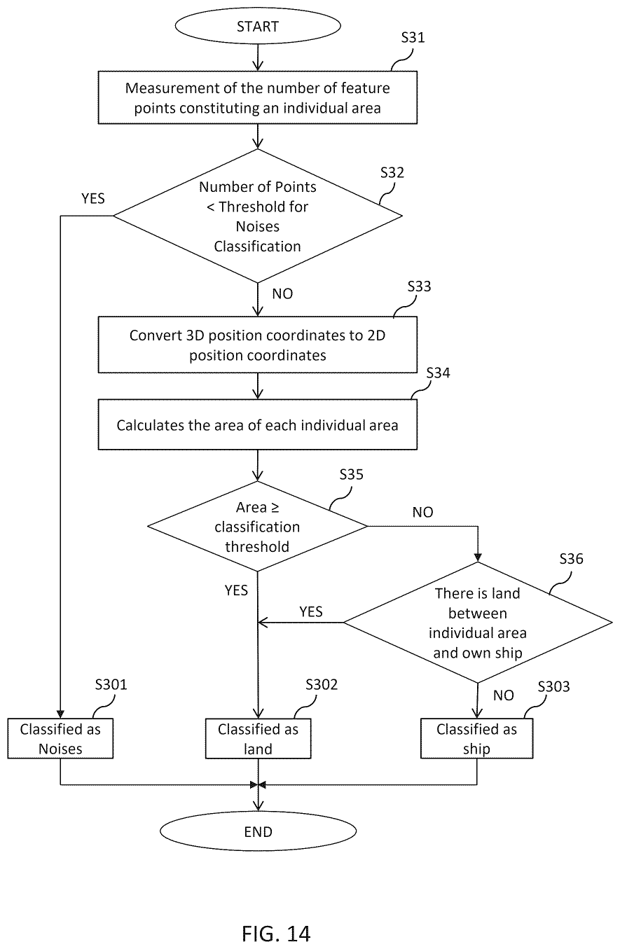

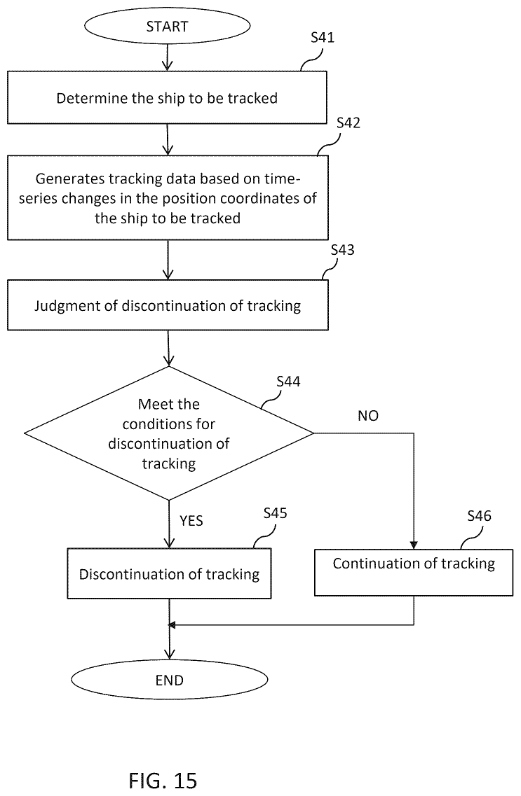

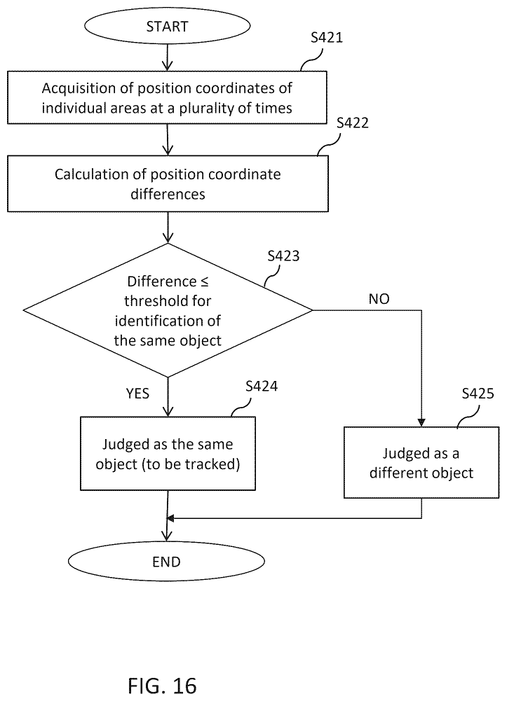

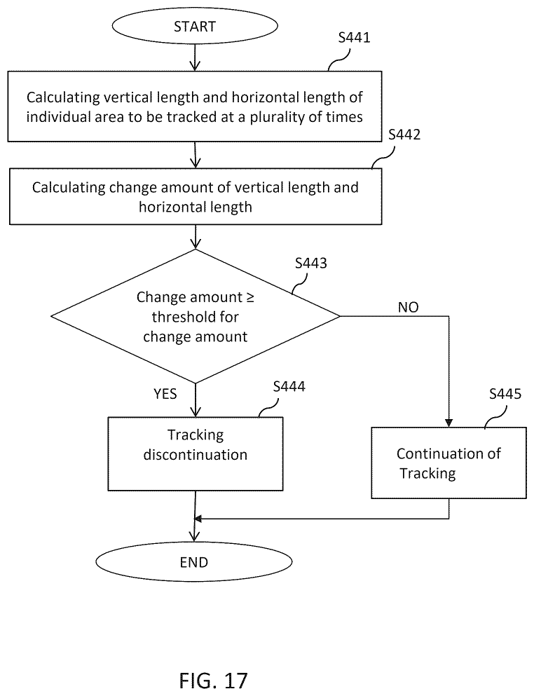

FIG. 11 is a flowchart showing an example of a ship tracking method according to a first embodiment of the present invention. FIG. 12 is a flowchart showing an example of an area setting method. FIG. 13 is a flowchart showing an example of an alignment method. FIG. 14 is a flowchart showing an example of a classification method. FIG. 15 is a flowchart showing an example of a tracking method. FIG. 16 is a flowchart showing an example of a tracking object determination method. FIG. 17 is a flowchart showing an example of a method for selecting a tracking continuation or a tracking termination.

The ship tracking method is, for example, programmed (i.e., a ship tracking program) and stored in a storage medium or the like. The arithmetic processor reads and executes the ship tracking program from the storage medium or the like. Thus, the ship tracking method is realized.

Since the specific contents of each process shown in FIGS. 11 to 17 have already been described in the above description of the structure and the process, the description will be omitted except for the unit that requires additional explanation.

(Overall processing: FIG. 11) As shown in FIG. 11, an arithmetic processing unit acquires point cloud data (S10). The arithmetic processing unit determines the individual areas of the point cloud data (S20). The arithmetic processing unit classifies the individual areas (S30). Specifically, the arithmetic processing unit classifies the type of the individual areas as the land or the ship.

The arithmetic processing unit selects the target tracking ship (S40). The arithmetic processing unit tracks the target tracking ship (S50).

(Area setting processing: FIG. 12) As shown in FIG. 12, the arithmetic processing unit stores the point cloud data at multiple times (S21). The arithmetic processing unit aligns the feature point data at the plurality of times included in the point cloud data at the plurality of times (S22).

The arithmetic processing unit determines the individual area based on the aligned feature point data at the plurality of times (S23).

(Alignment processing: FIG. 13) As shown in FIG. 13, if there is classification information (S221: YES), the arithmetic processing unit calculates a land percentage (S222).

In one embodiment, if the land percentage is above a percentage threshold (S223: NO), the arithmetic processing unit performs the alignment using the SLAM processing (S224).

In another embodiment, if the land percentage is below the percentage threshold (S223: YES), the arithmetic processing performs the alignment without using the SLAM processing (S225).

In another embodiment, if there is no classification information (S221: NO), the arithmetic processing unit performs the alignment using the SLAM processing (S224).

(Classification processing: FIG. 14) As shown in FIG. 14, the arithmetic processing unit measures the number of feature points constituting the individual areas (S31). The arithmetic processing unit compares the number of points with the threshold for noise classification. If the number of points is less than the threshold for the noise classification (S32: YES), the arithmetic processing unit classifies the individual area as the noise (S301).

If the number of points is equal to or greater than the threshold for the noise classification (S32: NO), the arithmetic processing unit determines that the individual area is not the noise. The arithmetic processing unit further converts the three-dimensional position coordinates of the feature point data constituting the individual area determined not to be the noise into the two-dimensional position coordinates (S33).

Further, the arithmetic processing unit calculates the size of each individual area subjected to a two-dimensional conversion (S34). If the size is equal to or greater than the classification threshold (S35: YES), the arithmetic processing unit classifies the individual area as the land (S302).

In one embodiment, if the size of the individual area to be classified is less than the classification threshold (35: NO) and the individual area classified as the land is located between the individual area to be classified and the ship (S36: YES), the arithmetic processing unit classifies the individual area as the land (S302).

In another embodiment, if the size of the individual area to be classified is less than the classification threshold (S35: NO) and the individual area classified as the land is not between the individual area to be classified and the ship (S36: NO), the arithmetic processing unit classifies the individual area as the ship (S303).

(Tracking processing: FIG. 15) As shown in FIG. 15, the arithmetic processing unit determines the target tracking ship (S41). Further, the arithmetic processing unit uses the processing shown in FIG. 16. The arithmetic processing unit generates the tracking data based on the time-series changes in the position coordinates of the tracked ship (S42).

Using the processing shown in FIG. 17, the arithmetic processing unit determines whether the tracking of the ship is stopped (S43). Further, the arithmetic processing unit specifically uses the processing shown in FIG. 17. When the tracking stop condition is satisfied (S44: YES), the arithmetic processing unit stops the tracking (S45). If the tracking stop condition is not satisfied (S44: NO), the arithmetic processing unit continues the tracking (S46).

(Tracking object determination processing: FIG. 16) As shown in FIG. 16, the arithmetic processing unit acquires the position coordinates of the individual areas at the plurality of times (S421). The arithmetic processing unit calculates a difference in the position coordinates of the individual areas at the plurality of times (S422).

If the difference is equal to or less than the determination threshold value of the same object mark (S423: YES), the arithmetic processing unit determines the same object mark (tracking object) (S424). If the difference is not equal to or less than the determination threshold value of the same object mark (S423: NO), the arithmetic processing unit determines the different object mark (S425).

(Process for selecting to continue or stop tracking: FIG. 17) As shown in FIG. 17, the arithmetic processing unit calculates the vertical length and/or the horizontal length of the individual areas of the plurality of times to be tracked (S441). The arithmetic processing unit calculates the amount of change in the vertical length and/or the horizontal length (S442).

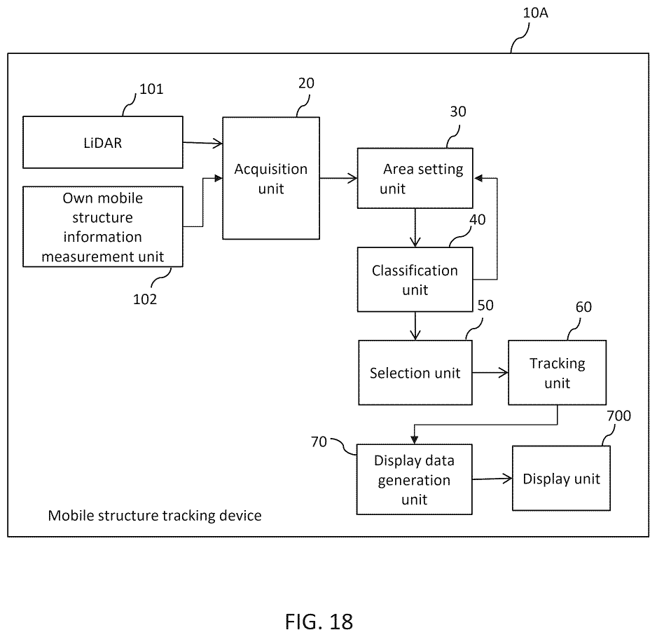

If the amount of change is equal to or greater than the threshold for the amount of change (S443: YES), the arithmetic processing unit stops the tracking (S444). If the amount of change is not equal to or greater than the threshold for the amount of change (S443: NO), the arithmetic processing unit continues the tracking (S445).

[Second Embodiment] A ship tracking technique according to a second embodiment of the present invention is described with reference to the figure. FIG. 18 is a functional block diagram of a mobile structure tracking device according to a second embodiment of the present invention.

As shown in FIG. 18, the mobile structure tracking device 10A according to the second embodiment differs from the mobile structure tracking device 10 according to the first embodiment in that it has a display function. The other configuration of the mobile structure tracking device 10A according to the second embodiment is the same as that of the mobile structure tracking device 10 according to the first embodiment, and the description of similar units will be omitted.

The mobile structure tracking device 10A includes a display data generation unit 70 and a display 700. The display 700 may be separate from the mobile structure tracking device 10A (i.e., separate configuration).

The display data generation unit 70 generates display data based on the tracking data of the tracked ship output by the tracking unit 60. The display data includes a present position display mark and a wake display mark. The present position display mark and the wake display mark are generated based on the position coordinates and the velocity vector included in the tracking data.

In one example, the present position display mark is a mark schematizing the ship, and its position and orientation are determined based on the direction components of the position coordinates and the velocity vector. The wake display mark is a rod-shaped mark, and its length is determined based on a velocity components of the velocity vector.

The display data generation unit 70 outputs the display data to the display 700. The display 700 is further configured to display the display data.

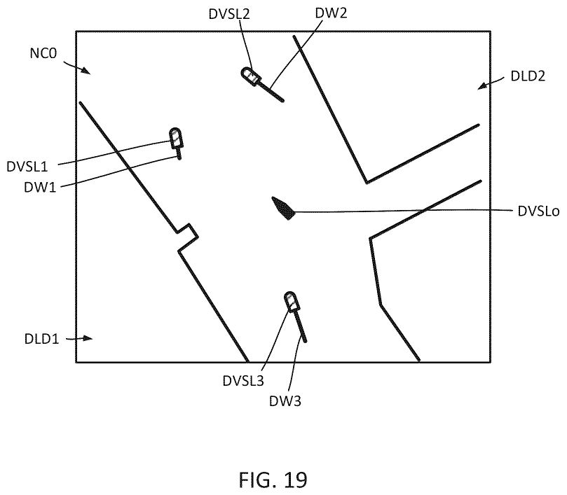

FIG. 19 is a diagram showing an example of the display. FIG. 19 shows a case where the tracking data is generated in the sea situation shown in the first embodiment, and the display data is generated based on the tracking data.

As shown in FIG. 19, the current position display marks DVSL1, DVSL2, and DVSL3 and the wake display marks DW1, DW2, and DW3 of a plurality of tracked ships are displayed on the display screen of the display 700 based on the display data.

Further, the user may easily visually grasp the current position, a navigation speed, and a navigation direction of the tracked ships. In one example, as shown in FIG. 19, the user may easily visually grasp the current position, the navigation speed, and the navigation direction of the tracked ships relative to the user's own ships by displaying the own ship position mark DVSLo based on the own ship information. Further, as shown in FIG. 19, the quay (land) marks DLD1 and DLD2 are displayed based on chart information, for example, so that the user 90 may easily visually grasp the current position, the navigation speed, and the navigation direction of the tracked ship in the narrow channel NC0 with reference to the ship.

The display data generation unit 70 may generate the display data with different display modes depending on a state of the tracked ship. The state of the tracked ship includes at least one of a distance, a bearing, and a speed from the own ship. The display mode includes at least one of color and size.

The display data generation unit 70 makes the display color different for each target tracking ship. The display data generation unit 70 makes the display of the target tracking ship close to the own ship different from the target tracking ship far away. The display data generation unit 70 further makes the display of the target tracking ship above a predetermined speed different from the target tracking ship below the predetermined speed.

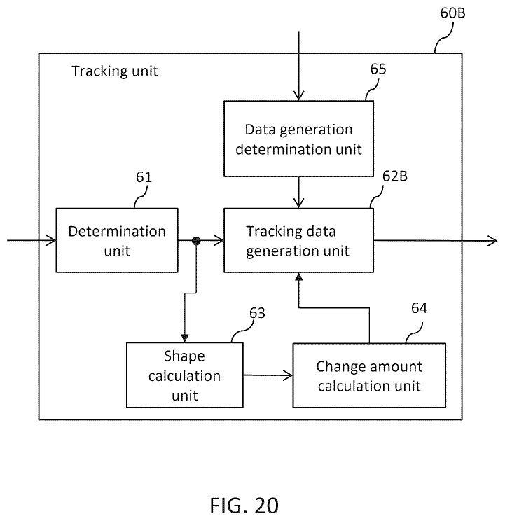

The mobile structure tracking device 10A is provided with an operator that accepts an operation from the user, and the display data generation unit 70 makes the display of the tracked ship selected by the operator different from other tracked ships.

[Third Embodiment] A ship tracking technique according to a third embodiment of the present invention will be described with reference to FIG. 3. FIG. 20 is a functional block diagram of a tracking unit in the mobile structure tracking device according to a third embodiment of the present invention.

As shown in FIG. 20, the mobile structure tracking device according to the third embodiment differs from the mobile structure tracking device 10 according to the first embodiment in the structure of the tracking unit 60B. The other structure of the mobile structure tracking device according to the third embodiment is the same as that of the mobile structure tracking device 10 according to the first embodiment, and the description of the same unit may be omitted.

The tracking unit 60B is different from the tracking unit 60 according to the first embodiment. The tracking unit 60B further includes a data generation determination unit 65, and in the additional processing performed by a tracking data generation unit 62B. Further, other configurations and processing of the tracking unit 60B are the same as those of the tracking unit 60, and the description of the same units may be omitted.

Based on the position coordinates of the individual area, the data generation determination unit 65 determines a tracked target ship corresponding to the individual area including feature point data included in the farthest area of an obtainable range of the point cloud data as the tracked target ship.

The data generation determination unit 65 also determines the tracked target ship corresponding to the individual area including the feature point data having the number of times acquired equal to or less than a threshold for the number of time acquired as the tracked target ship.

The data generation determination unit 65 outputs information (i.e., the position coordinates of the individual area) of the tracked target ship to be stopped to the tracked data generation unit 62B.

The tracked data generation unit 62B may not generate the tracked data for the tracked target ship to be stopped.

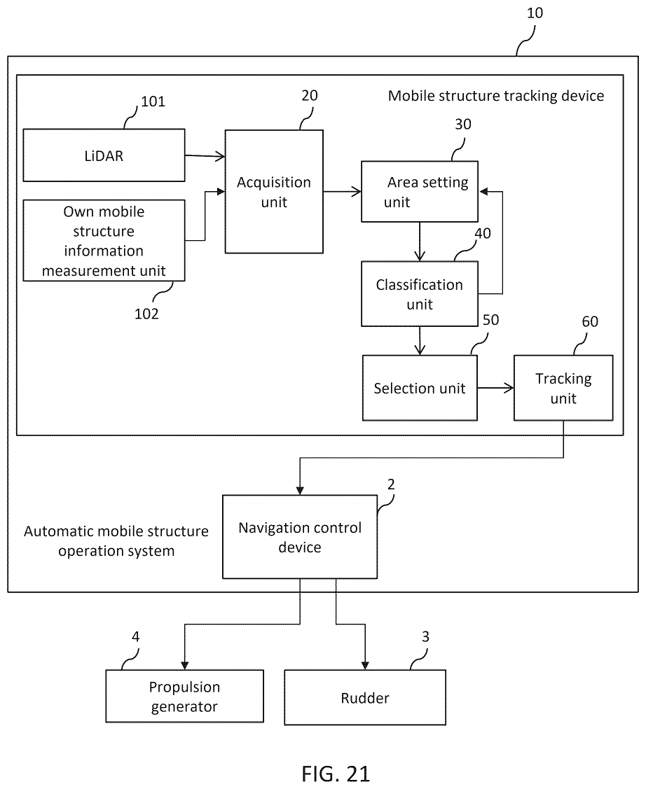

Further, the mobile structure tracking device may exclude the ship based on unreliable feature point data from the tracked target ship. The mobile structure tracking device may further generate reliable tracking data.

[Fourth Embodiment] A ship autopilot technology according to the fourth embodiment of the present invention may be described with reference to the figure. FIG. 21 is a functional block diagram of the ship autopilot system according to the fourth embodiment of the present invention.

As shown in FIG. 21, the automatic mobile structure control system 1 includes a mobile structure tracking device 10 and a navigation control device 2. The mobile structure tracking device 10 includes a configuration according to the first embodiment. The mobile structure tracking device 10 may further include a configuration according to the second and third embodiments described above.

The navigation control device 2 acquires tracking data from the mobile structure tracking device 10. The navigation control device 2 performs an automatic navigation control to follow the tracked ship based on the tracking data. The navigation control device 2 performs the automatic navigation control s to avoid collision with the tracked ship based on the tracking data. The navigation control device 2 controls a steering angle of a rudder 3 and an output of a propulsion generator 4 by the automatic navigation control.

With this configuration, the automatic mobile structure control system 1 may follow the tracked ship with high accuracy based on high accuracy tracking data of the tracked ship. Further, the automatic mobile structure control system 1 may more reliably avoid collision with the tracked ship.

While the above technology has been described using a ship as an example, it can be applied to any type of mobile structure, such as a car, airplane, or motorcycle.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A mobile structure tracking device, comprising:
processing circuitry configured to:
acquire point cloud data comprising a plurality of feature points obtained by a sensor ranging a surrounding environment including another mobile structure with respect to an own mobile structure;
set an individual area for the plurality of feature points based on a distribution of positions of the plurality of feature points;
select a target tracking mobile structure based on a size of the individual area; and
generate tracking data based on time-series changes in a position of the target tracking mobile structure.

2. The mobile structure tracking device according to claim 1,
wherein the plurality of feature points are three-dimensional position coordinates.

3. The mobile structure tracking device according to claim 2, wherein the processing circuitry is further configured to:
set the individual area using the three-dimensional position coordinates, and
generate the tracking data using two-dimensional position coordinates generated by converting the three-dimensional position coordinates into the two-dimensional position coordinates.

4. The mobile structure tracking device according to claims 1, wherein the processing circuitry is further configured to:
accumulate the point cloud data at a plurality of times;
perform alignment of the plurality of feature points included in the point cloud data at the plurality of times using SLAM processing; and
set the individual area based on the performing of the alignment of the plurality of feature points.

5. The mobile structure tracking device according to claims 1, wherein the processing circuitry is further configured to:
classify a type of the individual area,
select the target tracking mobile structure based on the type of the individual area.

6. The mobile structure tracking device according to claim 4, wherein the processing circuitry is further configured to:
determine whether or not to use SLAM processing in accordance with a ratio of the individual area classified as a land in a detection area by the sensor.

7. The mobile structure tracking device according to claim 6, wherein the processing circuitry is further configured to:
perform the alignment without using the SLAM processing when the ratio is equal to or less than a threshold ratio.

8. The mobile structure tracking device according to claim 7, wherein the processing circuitry is further configured to:
measure a position and an attitude of the own mobile structure,
perform the alignment using the position and the attitude of the own mobile structure when the SLAM processing is not used.

9. The mobile structure tracking device according to claim 5, wherein the processing circuitry is further configured to:
set the individual area for each set of feature points from the plurality of feature points having a distance between adjacent feature points equal to or less than an area setting threshold.

10. The mobile structure tracking device according to claim 5, wherein the processing circuitry is further configured to:
classify the type of the individual area as the land when a size of the individual area is greater than or equal to a classification threshold, and
classify the type of the individual area as a mobile structure when the size of the individual area is less than the classification threshold.

11. The mobile structure tracking device according to claim 10, wherein the processing circuitry is further configured to:
classify the type of the individual area as the land when the individual area classified as the land exists between the individual area to be classified and the own mobile structure.

12. The mobile structure tracking device according to claim 5, wherein the processing circuitry is further configured to:
classify the plurality of feature points as noise when a number of the feature points constituting the individual area is less than a noise classification threshold.

13. The mobile structure tracking device according to claim 12, wherein the processing circuitry is further configured to:
convert a three-dimensional position of the plurality of feature points of the individual area that is not classified as the noise into a two-dimensional position, and classify the type of the individual area as the mobile structure or the land based on the converted individual area.

14. The mobile structure tracking device according to claim 1, wherein the processing circuitry is further configured to:
determine whether or not the individual area at a plurality of times is caused by a same target object based on position coordinates at the plurality of times, and
calculate a time-series change of the position coordinates of the same target object.

15. The mobile structure tracking device according to claim 14, wherein the processing circuitry is further configured to:
calculate a vertical length or a horizontal length of the individual area at the plurality of times determined to be the same target object,
calculate a change amount of the vertical length or the horizontal length at the plurality of times, and
refrain from calculating the time-series change of the position coordinates of the same target object when the change amount of the vertical length or horizontal length at the plurality of times is equal to or greater than a change threshold.

16. The mobile structure tracking device according to claim 1, wherein the processing circuitry is further configured to:
refrain from generating the tracking data for the target tracking mobile structure corresponding to the individual area comprising the plurality of feature points included in a farthest area in the detection area by the sensor, or the plurality of feature points having a number of times acquired is less than or equal to a threshold for the number of times acquired.

17. The mobile structure tracking device according to claim 1, wherein the processing circuitry is further configured to:
generate display data based on the tracking data, and wherein the device further comprises,
a display configured to display the display data.

18. The mobile structure tracking device according to claim 1, wherein the processing circuitry is further configured to:
perform an automatic navigation control to follow the target tracking mobile structure or avoid collision with the target tracking mobile structure based on the tracking data.

19. A mobile structure tracking method, comprising:
acquiring point cloud data comprising a plurality of feature points obtained by a sensor ranging a surrounding environment including another mobile structure with respect to an own mobile structure;
setting an individual area for the plurality of feature points based on a distribution of positions of the plurality of feature points;
selecting a target tracking mobile structure based on a size of the individual area; and
generating tracking data based on time-series changes in a position of the target tracking mobile structure.

20. A non-transitory computer-readable medium having stored thereon computer-executable instructions which, when executed by a computer, cause the computer to:
acquire point cloud data comprising a plurality of feature points obtained by a sensor ranging a surrounding environment including another mobile structure with respect to an own mobile structure;
set an individual area for the plurality of feature points based on a distribution of positions of the plurality of feature points;
select a target tracking mobile structure based on a size of the individual area; and
generate tracking data based on time-series changes in a position of the target tracking mobile structure.
